(19) United States
(12) Patent Application Publication
(10) Pub. No.: US 2010/0044344 A1
(43) Pub. Date: Feb. 25, 2010

(54) Silicon Nanoparticle Formation From Silicon Powder and Hexacholorplatinic Acid

(76) Inventors: Munir H. Nayfeh, Urbana, IL (US); Jon Host, Midland, MI (US); David Nielsen, Champaign, IL (US)

Correspondence Address: GREER, BURNS & CRAIN, 300 S WACKER DR, 25TH FLOOR, CHICAGO, IL, 60606, US

(21) Appl. No.: 11/989,334

(22) PCT Filed: Jul. 25, 2006
(86) PCT No.: PCT/US06/28816

§ 371 Date: Oct. 29, 2009

Related U.S. Application Data
(60) Provisional application No. 60/702,673, filed on Jul. 26, 2005.

(51) Int. Cl. B44C 1/22

(52) U.S. Cl. 216/99

(57) ABSTRACT

A silicon nanoparticle formation method that can rapidly produce substantial quantities of silicon nanoparticles, which are readily recoverable for subsequent uses. Methods of the invention treat silicon powder in hexachloroplatinic acid. The treated silicon powder is then etched with an etching solution of HF/H₂O₂ to form Si nanoparticles

### FIELD OF THE INVENTION

The invention concerns silicon nanoparticles. Applications of the invention include a wide range of electronic and opto-electronic applications.

### BACKGROUND

Various methods exist in the art for the production of silicon nanoparticles. Most methods are directed to production of silicon nanoparticles having a wide size distribution. In addition, many prior methods, e.g., laser ablation of silicon material, make recovery of silicon nanoparticle for ex-situ uses difficult. There also exist in the art methods for producing size distributions of silicon nanoparticles, sometimes with small quantities of 1 nm particles, but typically having particles tending toward a 10 nm size and greater. Laser ablation, pyrolosis of gas, and electron beam deposition are exemplary processes that have been used in the art to produce silicon nanoparticles, but the processes generally produce small quantities of particles, and in forms that are not readily accessed for subsequent processes.

The state of the art was advanced by methods for the controlled production of silicon nanoparticles that also permitted their recovery and ex-situ use. Silicon nanoparticles of ˜1 nm diameter have been produce in quantity with high uniformity of the specific 1 nm size. See, Nayfeh et al. U.S. Pat. No. 6,585,947, entitled METHOD FOR PRODUCING SILICON NANOPARTICLES; Nayfeh et al. U.S. Published Patent Application, as publication number 20020070121, published on Jul. 13, 2002 and entitled FAMILY OF DISCRETELY SIZED NANOPARTICLES AND METHOD FOR PRODUCING THE SAME. See, also e.g., Akcakir et al, “Detection of luminescent single ultrasmall silicon nanoparticles using fluctuation correlation spectroscopy”, Appl. Phys. Lett. 76 (14), p. 1857 (Apr. 3, 2000). The family includes 1 (blue emitting), 1.67 (green emitting), 2.15 (yellow emitting), 2.9 (red emitting) and 3.7 nm (infrared emitting). See, also, e.g., G. Belomoin et al. “Observation of a magic discrete family of ultrabright Si nanoparticles,” Appl. Phys. Lett. 80(5), p 841 (Feb. 4, 2002).

### SUMMARY OF INVENTION

The invention provides a silicon nanoparticle formation method that can rapidly produce substantial quantities of silicon nanoparticles, which are readily recoverable for subsequent uses. Methods of the invention treat silicon powder in hexachloroplatinic acid. The treated silicon powder is then etched with an etching solution of HF/H₂O₂ to form Si nanoparticles.

### DESCRIPTION OF EXEMPLARY PREFERRED EMBODIMENTS

The invention provides silicon nanoparticle formation processes that proceed to completion quickly, permitting formation of large quantities of nanoparticles.

The rapidity of preferred embodiment formation methods makes them especially well-suited to commercial manufacturing processes. Substantial quantities of silicon nanoparticles can be produced rapidly. Preferred embodiments will now be discussed. Artisans will appreciate broader aspects of the invention from the description of the preferred embodiments.

A preferred embodiment of the invention is chemical process utilizing hexachloroplatinic acid/HF/H₂O₂ combination to convert silicon powder into fluorescent silicon nanoparticles. The process of the invention is a fast process that is capable of producing substantial quantities of silicon nanoparticles and uses silicon powder, which is a readily available low-cost byproduct of the silicon industry.

Experiments concerning the above embodiments will now be discussed. The laboratory scale demonstrations of preferred embodiments will reveal additional features of the invention to artisans.

To prepare a treatment solution, 0.1518 g of hexachloroplatinic acid (H₂PtCl₆.H₂O) (HCPA) was dissolved in 30 ml of de-ionized water. This results in ˜0.0089 M solution. Silicon powder is added and the treatment solution. The powder is treated in the treatment solution while the solution is magnetically stirred. Then, the magnetic stirrer is turned off and the excess HF/chloroplatinic acid is drained. This is followed by the addition of a mix of HF/H₂O₂ etchant to the treated powder incrementally in small amounts. Exposure of the powder to the etchant for a short period of two minutes or less successfully produces substantial quantities of silicon nanoparticles. Very short periods, e.g., 15 seconds, produce silicon nanoparticles. The etching is very aggressive and little mixing is needed during the etching step. The overall etching time is not critical and can be more than two minutes, but shorter times give higher yields. The HF/H₂O₂ etchant is then diluted by adding water or/and alcohol and drained. Finally, the powder is washed with water and drained to remove any left over acid.

When the processed powder is illuminated with 365 nm from a mercury lamp, red/yellow fluorescence is seen from the powder with the naked eye. The procedure produces a size distribution, with a 6 to 1 nm size range of the nanoparticles according to scanning electron microscopy. The average size is ˜3 nm, which exhibits red/yellow photoluminescence. The process works in zero current. However, current could also be supplied during the hexochloroplatinic treatment and/or during the etching of the treated silicon powder through the use of two electrodes immersed in the etchant solution near opposite ends of the bath to catalyze the process further. In the experiments, a silicon powder with an average grain size of 90 micrometer, available commercially from Dow Chemical, was used. Many other product powder families can be used with different grain sizes or shapes such as flakes and different levels of surface contamination. For example, the procedure was successfully applied to commercial silicon flakes and to crushed silicon wafers.

Scanning electron imaging shows formation of platinum nanoparticles as a byproduct with a wide size distribution covering the range 1-300 nm in diameter. Some of these platinum particles are decorated with the fluorescent silicon nanoparticles, which gives them a glowing look under UV irradiation.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A method for forming silicon nanoparticles, the method comprising steps of:
preparing a treatment solution of hexachloroplatinic acid, HF, and water;
mixing silicon powder into the treatment solution;
permitting treatment of the silicon powder in the treatment solution;
draining excess treatment solution from the silicon powder;
etching the silicon powder with an HF/H₂O₂ etchant solution to form silicon nanoparticles;
draining the etchant solution from the silicon nanoparticles.

2. The method of claim 1, further comprising a step of recovering the silicon nanoparticles.

3. The method of claim 1, further comprising a step of supplying current to the etching solution to catalyze the step of etching.

4. The method of claim 3, wherein said step of supplying a current comprises placing electrodes in the etchant solution and supplying power to the electrodes.

5. The method of claim 1, wherein said etching is conducted for a short period of two minutes or less.

6. The method of claim 1, wherein said step of mixing silicon powder comprises magnetically stirring the treatment solution while adding the silicon powder.

7. The method of claim 1, wherein said step of etching comprises incrementally adding the HF/H₂O₂ etchant to the silicon powder.

8. The method of claim 7, wherein said step of draining comprises first diluting the HF/H₂O₂ etchant and then draining diluted HF/H₂O₂ etchant.

9. The method of claim 8, further comprising a step of washing the silicon nanoparticles with water to remove any left over HF/H₂O₂ etchant.
